(19) United States
(12) Patent Application Publication
(10) Pub. No.: US 2007/0151794 A1
(43) Pub. Date: Jul. 5, 2007

(54) Electric power steering apparatus

(75) Inventors: Hiroto Mizutani, Gunma (JP); Osamu Tatewaki, Gunma (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD., Tokyo (JP)

(21) Appl. No.: 10/586,365

(22) PCT Filed: Dec. 28, 2005
(86) PCT No.: PCT/JP05/24142

§ 371 Date: Jul. 18, 2006

(30) Foreign Application Priority Data
Dec. 28, 2004 (JP) 2004-381681
Jan. 25, 2005 (JP) 2005-017257
Jan. 28, 2005 (JP) 2005-022075
Mar. 22, 2005 (JP) 2005-082230

(51) Int. Cl. B62D 5/04

(52) U.S. Cl. 180/444

(57) ABSTRACT

In an electric power steering apparatus, in which an auxiliary steering torque is generated by an electric motor according a steering torque impressed upon a steering wheel transmitted to a rack shaft of a steering mechanism via a power transmission mechanism. The power transmission mechanism has a small diameter external gear, and an outer circumferential face thereof acts as a drive side pulley, a driven side pulley driven by the internal-external gear and a ball screw mechanism driven by the driven side pulley so as to move the rack shaft. A circular support body is concentrically provided at the external gear and an annular support body, which supports the circular support body, is concentrically provided at the internal-external gear so as to be inscribed with the circular support body.

### TECHNICAL FIELD

The present invention relates to a ball screw type different shaft type rack-assisting type electric power steering apparatus.

### BACKGROUND ART

In a field of a power steering system incorporated into a vehicle, a so-called power steering system, in which steering operation is assisted by an external power source, is widely used. It is conventional to use a vane type hydraulic pump for the power source of the power steering apparatus. In many cases, this hydraulic pump is driven by an engine mounted on the vehicle. However, in this type power steering apparatus, since the hydraulic pump is driven by the engine at all times, loss of power in the engine becomes large (when a maximum load is given to the hydraulic pump, the loss of power is several horsepower or 10 horse power). Therefore, it is difficult to apply this type power steering apparatus to a light car, of which engine displacement is small. Also, even when this type power steering apparatus is applied to an vehicle, of which engine displacement is relatively large, it is impossible to evade a reduction in the fuel consumption and this reduction in the fuel consumption is not negligible.

As a countermeasure for solving these problems, they are recently paying attention to an Electric Power steering apparatus, which will be referred to as EPS hereinafter, the power source of which is an electric motor. In the case of EPS, since a battery mounted on an vehicle is used as an electric power source for driving the electric motor, no direct power loss is caused in the engine. Since the electric motor is set in motion only when it assists the steering operation, the following characteristics can be exhibited. A reduction in the fuel consumption can be suppressed. Further, electronic control can be easily conducted on the steering system.

On the other hand, concerning the steering gear used for the vehicle, a rack and pinion type steering gear becomes a mainstream at present because the rigidity of the rack and pinion type steering gear is high and further the weight is light. As EPS for the rack and pinion type steering gear, a column assisting type electric power steering apparatus is used in which an electric motor is arranged on a column side so as to drive a steering shaft and pinion themselves. Further, a ball screw type rack-assisting type electric power steering apparatus is used in which a rack shaft is driven by an electric ball screw mechanism. When the ball screw type rack-assisting type electric power steering apparatus is used, an assisting force does not act on an engagement face on which a pinion and a rack are engaged with each other. Therefore, it is possible to reduce a contact surface pressure, which can be a cause of abrasion or deformation, to a relatively low value.

In the case of the rack-assisting type EPS, male screw grooves of a ball screw shaft, which are formed on a rack shaft, and female screw grooves, which are formed on a ball nut, are engaged with each other via a large number of circulating balls (steel balls). The ball nut is rotated being driven by an electric motor that is arranged on the same shaft as the rack shaft or on a different shaft from the rack shaft. Due to the foregoing, the rack shaft is moved in the axial direction.

As a method of transmitting power from the electric motor to the ball nut in the different shaft type rack-assisting type EPS, it is commonly employed a gear type or a timing belt type power transmitting system.

In the meanwhile, in the different shaft type rack-assisting type EPS described in Patent Document 1, a power transmitting mechanism includes: an external gear driven by an electric motor and having external teeth; a ring-shaped internal gear, which has internal teeth to be inscribed and meshed with this external gear and which is also swingably supported round an axis of the external gear; a drive side pulley provided on an outer circumferential face of this internal gear; a driven side pulley driven by this drive side pulley via a belt; and a ball screw mechanism driven by this driven side pulley so as to move the rack shaft.

As described above, according to Patent Document 1, after the rotary speed has been reduced by the external and the internal gear, and further it is reduced by the drive side and the driven side pulley. That is, the rotary speed can be reduced by a reduction gear ratio of two stages. Accordingly, even if a diameter of the drive side pulley is not decreased or a diameter of the driven side pulley is not increased, it is possible to accomplish a high reduction gear ratio by the entire reduction gear mechanism with small size. Therefore, the power steering apparatus can be easily mounted on a vehicle. Further, it is unnecessary to decrease a radius of curvature of a belt winding region of the drive side pulley. Accordingly, the life of the belt can be extended.

In Patent Document 1, by guide sections which are provided at both end portions of the drive side pulley being integrated with the housing into one body, a movement of the drive side pulley in the axial direction is regulated.

Patent Document 1: Japanese Patent Unexamined Publication JP-A-2004-262264 (WO 2004/069631 A1)

### Disclosure of the Invention

Problem to be Solved

In Patent Document 1, in belt tension which acts on the drive side pulley on which the belt is wound, force acting on radial direction (referred to as a radial force hereinafter) is received by tooth faces of the external and internal gear.

As a result, when the case is a common gear reducer, paying attention to one tooth of the gear, contact is made only on one side of the tooth. In this case (JP-A-2004-262264), contact is made on both faces of the tooth of each of the external and the internal gear. Accordingly, the internal gear bites the external gear, and the durable strength of the tooth is deteriorated and further the operation noise is increased and furthermore, the operation torque is increased.

The present invention has been accomplished in view of the above circumstances. An object of the present invention is to provide an electric power steering apparatus capable of enhancing the durable strength of teeth and reducing operation noise and operation torque.

Means for Solving the Problems

In order to accomplish the above object, according to the first aspect of the present invention, there is provided a different shaft type rack-assisting type electric power steering apparatus, in which an auxiliary steering torque is generated by an electric motor in accordance with a steering torque impressed upon a steering wheel and transmitted to a rack shaft of a steering mechanism via a power transmission mechanism, the power transmission mechanism including:

an external gear of which diameter is small, which is driven by the electric motor and has external teeth;

a ring-shaped internal-external gear, which has internal teeth inscribed and meshed with the external gear, is swingably supported around an axis of the external gear, and an outer circumferential face of which acts as a drive side pulley;

a driven side pulley driven by the internal-external gear via a belt; and

a ball screw mechanism driven by the driven side pulley so as to move the rack shaft,

wherein a circular support body is substantially concentrically provided at an end portion of the external gear; and

an annular support body, which supports the circular support body, is substantially concentrically provided at an end portion of the internal-external gear so as to be inscribed with the circular support body.

According to a second aspect as set forth in the first aspect of the present invention, there is provided the electric power steering apparatus, wherein an outer diameter of the circular support body is set substantially the same as a pitch circle diameter of the internal teeth of the external gear, and

an inner diameter of the annular support body is set substantially the same as a pitch circle diameter of the internal teeth of the internal-external gear.

According to a third aspect as set forth in the first aspect of the present invention, there is provided the electric power steering apparatus, wherein the circular support body and the annular support body respectively has a movement regulating mechanism for regulating a movement of the internal-external gear in the axial direction.

According to a fourth aspect as set forth in the third aspect of the present invention, there is provided the electric power steering apparatus, wherein an outer diameter of the circular support body is set substantially the same as a pitch circle diameter of the external gear, and

an inner diameter of the annular support body is set substantially the same as a pitch circle diameter of the internal teeth of the internal-external gear.

According to a fifth aspect as set forth in the third aspect of the present invention, there is provided the electric power steering apparatus, wherein in the movement regulating mechanism, shape of contact portions, in which the circular support body contacts with the annular support body, are formed in such a manner that one is formed into a protruding shape and the other is formed into a recessing shape.

According to a sixth aspect as set forth in the third aspect of the present invention, there is provided the electric power steering apparatus, wherein in the movement regulating mechanism, shape of contact portions, in which the circular support body contacts with the annular support body, are formed in such a manner that both are formed into tapered shape, opposed to each other and symmetrically to each other.

According to a seventh aspect as set forth in the first aspect of the present invention, there is provided the electric power steering apparatus, wherein a flange is provided on a side of the internal-external gear.

According to an eighth aspect as set forth in the seventh aspect of the present invention, there is provided the electric power steering apparatus, wherein the flange is formed integrally with the annular support body, which is provided at an end portion of the internal-external gear.

According to a ninth aspect as set forth in the first aspect of the present invention, there is provided the electric power steering apparatus, wherein external teeth of the external gear, internal teeth of the internal-external gear, outer circumferential face engagement teeth of the internal-external gear, engagement teeth of the belt and outer circumferential face engagement teeth of the driven side pulley are respectively set to be oblique teeth, and

twist directions of these oblique teeth are set to be in the same direction.

According to a tenth aspect as set forth in the ninth aspect of the present invention, there is provided the electric power steering apparatus, wherein

twist angle of the internal tooth of the internal-external gear is set θₐ,

twist angle of the outer circumferential face engagement tooth of the internal-external gear is set θ_{b},

pitch circle radius of engagement of the internal tooth of the internal-external gear is set rₐ, and

pitch circle radius of engagement of the outer circumferential face engagement tooth of the internal-external gear with the engagement tooth of the belt is set r_{b},

wherein θₐ, θ_{b}, rₐ and r_{b} are set so as to satisfy following relation.
(r_{b}/rₐ)=(tan θ_{b}/tan θₐ) (Formula 4)

According to an eleventh aspect as set forth in the first aspect of the present invention, there is provided the electric power steering apparatus, wherein the electric power steering apparatus is used for steering rear wheels in a four wheel steering system.

According to a twelfth aspect as set forth in the first aspect of the present invention, there is provided the electric power steering apparatus, wherein the electric power steering apparatus is used for a steer-by-wire type steering system in which the steering wheel and the rack shaft are not mechanically connected to each other.

### Advantage of the Invention

According to the present invention, the power transmission mechanism further includes: a circular support body provided at an end portion of the external gear substantially concentrically; and an annular support body, which is inscribed with and support the circular support body, substantially concentrically provided at an end portion of the internal-external gear.

Therefore, the radial force in the tension acting on the drive side pulley can be supported by the circular support body and the annular support body. Accordingly, both gears can take charge of only a transmission of torque.

Accordingly, the radial force caused by the belt tension does not act on both gears. Consequently, there is no fear that the internal-external gear bites the external gear. Therefore, the durable strength of the tooth can be enhanced and the generation of operation noise can be reduced. Further, the operation torque can be reduced.

An outer diameter of the circular support body is set substantially the same as the diameter of the pitch circle of the external gear, and an inner diameter of the annular support body is set substantially the same as the diameter of the pitch circle of the internal teeth of the internal-external gear. Therefore, the circular support body and the annular support body come into contact with each other not by sliding contact but by rolling contact. Accordingly, an increase in the operation torque, which is accompanied by abrasion, can be reduced as small as possible.

Further, according to the present invention, the circular support body and the annular support body respectively have a movement regulating mechanism for regulating a movement in the axial direction of the internal-external gear. Further, in the movement regulating mechanism, shape of the contact portions, in which the circular support body contacts with the annular support body, are formed in such a manner that one is formed into a protruding shape and the other is formed into a recessing shape.

By this protrusions and recesses, it is possible to regulate a movement of the internal-external gear in the axial direction. Therefore, it is possible to prevent the internal-external gear from coming into contact with a housing and others.

Therefore, an increase in the operation torque and a deterioration of the durability caused by the sliding contact can be suppressed. Further, the generation of noise can be prevented.

Further, concerning the shapes of a protrusion and a recess, for example, a radius of curvature of the protrusion and that of the recess are made to be different from each other. That is, the contact portion is substantially made to be a state of point contact. Due to this structure, an area of the contact portion is made to be small, that is, rolling contact is accomplished while the contact portion is being made to be in a state of point contact. Therefore, the occurrence of friction and abrasion can be remarkably reduced.

In the movement regulating mechanism, shape of the contact portions, in which the circular support body contacts with the annular support body, are formed in such a manner that both are respectively formed into a tapered shape, opposed to each other and further both are formed symmetrically to each other.

Due to the tapered and symmetric shape of the contact portions, it is possible to regulate a movement of the internal-external gear in the axial direction. Therefore, the internal-external gear can be prevented from coming into contact with the housing and others.

Therefore, an increase in the operation torque and a deterioration of the durability caused by the sliding contact can be suppressed. Further, the generation of noise can be prevented.

Further, due to the tapered and symmetric shape of the contact portions, the contact portion is substantially made to be in a state of point contact. Due to this structure, an area of the contact portion is made to be small, that is, rolling contact is accomplished while the contact portion is being made to be in a state of point contact. Therefore, the occurrence of friction and abrasion can be remarkably reduced.

According to the present invention, flanges are provided on both sides of the internal-external gear, so that a movement of the belt in the axial direction can be regulated. Due to the foregoing, the belt can be prevented from moving in the axial direction and coming into contact with the housing and others. Therefore, an increase in the operation torque and a deterioration of the durability can be suppressed. Further, the generation of noise can be prevented.

The flanges are formed being integrated with the annular support, which is provided at end portions of the internal-external gear, into one body. Therefore, it is possible to omit a means for separately attaching the flanges. Further, it is possible to reduce a wall thickness of the attaching portion. Therefore, the structure can be made compact.

According to the present invention, external teeth of the external gear, internal teeth of the internal-external gear, outer circumferential face engagement teeth of the internal-external gear, engagement teeth of the belt and outer circumferential face engagement teeth of the driven side pulley are respectively set to be oblique teeth, and directions of twist of these oblique teeth are set to be in the same direction.

Due to the foregoing, a direction of the force for moving the internal-external gear in the axial direction, which is generated from an engagement of the external teeth of the external gear with the internal teeth of the internal-external gear, and direction of the force for moving the internal-external gear in the axial direction, which is generated from an engagement of the outer circumferential face engaging teeth of the internal-external gear with the engagement teeth of the belt, can be set to be reverse to each other. As a result, it is possible to regulate a movement of the internal-external gear from moving in the axial direction.

According to the present invention, when a twist angle of the internal tooth of the internal-external gear is set to be θₐ, a twist angle of the outer circumferential face engagement tooth of the internal-external gear is set to be θ_{b}, a pitch circle radius of engagement of the internal tooth of the internal-external gear is set to be rₐ, and a pitch circle radius of engagement of the outer circumferential face engagement tooth of the internal-external gear with the engagement tooth of the belt is set to be r_{b}, θₐ, θ_{b}, rₐ and r_{b} are set so as to satisfy following relation.
(r_{b}/rₐ)=(tan θ_{b}/tan θₐ) (Formula 4)

Due to the foregoing, the force for moving the internal-external gear in the axial direction, which is generated from an engagement of the external teeth of the external gear with the internal teeth of the internal-external gear, and direction of the force for moving the internal-external gear in the axial direction, which is generated from an engagement of the outer circumferential face engaging teeth of the internal-external gear with the engagement teeth of the belt, can be set to be equal to each other. As a result, it is possible to regulate a movement of the internal-external gear from moving in the axial direction.

Accordingly, it is possible to regulate a movement of the internal-external gear in the axial direction, and an increase in the operation torque and a deterioration of the durability can be suppressed. Further, the generation of noise can be prevented.

### BRIEF DESCRIPTION OF THE DRAWINGS

[FIG. 1]

FIG. 1 is a longitudinal sectional view of a ball screw type different shaft type rack-assisting type electric power steering apparatus of an embodiment of the present invention.

[FIG. 2]

FIG. 2 is a sectional view taken on line A-A (on one-dotted chain line side) in FIG. 1.

[FIG. 3]

FIG. 3 is a sectional view taken on line B-B (on two-dotted chain line side) in FIG. 1.

[FIG. 4]

FIG. 4 is a longitudinal sectional view of a ball screw type different shaft type rack-assisting type electric power steering apparatus of the second embodiment of the present invention.

[FIG. 5]

FIG. 5 is an enlarged sectional view showing a contact portion of a circular support body with an annular support body of the second embodiment of the present invention.

[FIG. 6A]

FIG. 6A is an enlarged sectional view showing a contact portion of a circular support body with an annular support body of a variation of the second embodiment of the present invention.

[FIG. 6B]

FIG. 6B is an enlarged sectional view showing a contact portion of a circular support body with an annular support body of a variation of the second embodiment of the present invention.

[FIG. 6C]

FIG. 6C is an enlarged sectional view showing a contact portion of a circular support body with an annular support body of a variation of the second embodiment of the present invention.

[FIG. 7]

FIG. 7 is an enlarged sectional view showing a primary portion of a ball screw type different shaft type rack-assisting type electric power steering apparatus of the third embodiment of the present invention.

[FIG. 8]

FIG. 8 is a longitudinal sectional view showing a ball screw type different shaft type rack-assisting type electric power steering apparatus of the fourth embodiment of the present invention.

[FIG. 9]

FIG. 9 is a longitudinal sectional view showing a ball screw type different shaft type rack-assisting type electric power steering apparatus of the fifth embodiment of the present invention.

[FIG. 10A]

FIG. 10A is an enlarged sectional view showing a circular support body and an annular support body shown in FIG. 9.

[FIG. 10B]

FIG. 10B is an enlarged sectional view showing a circular support body and an annular support body of the sixth embodiment of the present invention.

[FIG. 10C]

FIG. 10C is an enlarged sectional view showing a circular support body and an annular support body of the seventh embodiment of the present invention.

[FIG. 11]

FIG. 11 is a longitudinal sectional view showing a ball screw type different shaft type rack-assisting type electric power steering apparatus of an embodiment of the present invention.

[FIG. 12A]

FIG. 12A is an enlarged schematic illustration showing a portion in which the external gear, internal-external gear and belt shown in FIG. 11 are meshed with each other.

[FIG. 12B]

FIG. 12B is a schematic illustration in which an engagement pitch line (X) of an external tooth of an external gear with an internal tooth of an internal-external gear is shown by a broken line and a pitch line of an outer circumferential face engagement tooth of the internal-external gear with an engagement tooth of a belt is shown by a solid line (Y).

### DESCRIPTION OF THE REFERENCE NUMERALS AND SIGNS

1, 2, 3 Housing (Steering gear case)

4 Electric motor

5 Drive shaft

7 Pivot shaft

8, 9 Bearing

11 External gear of small diameter

12 Ring-shaped internal-external gear

12a Internal tooth

12b Outer circumferential face engaging tooth

13 Driven side pulley

14 Belt

21 Rack shaft

22 Ball nut

23 Male screw groove

24 Female screw groove

25 Steel ball

26 Double row bearing

27 Cylindrical body

28 Spline portion

31 Circular support body

32 Annular support body

40 Flange

41 Oblique tooth belt

### BEST MODE FOR CARRYING OUT THE INVENTION

Referring to the accompanying drawings, an electric power steering apparatus of an embodiment of the present invention will be explained below.

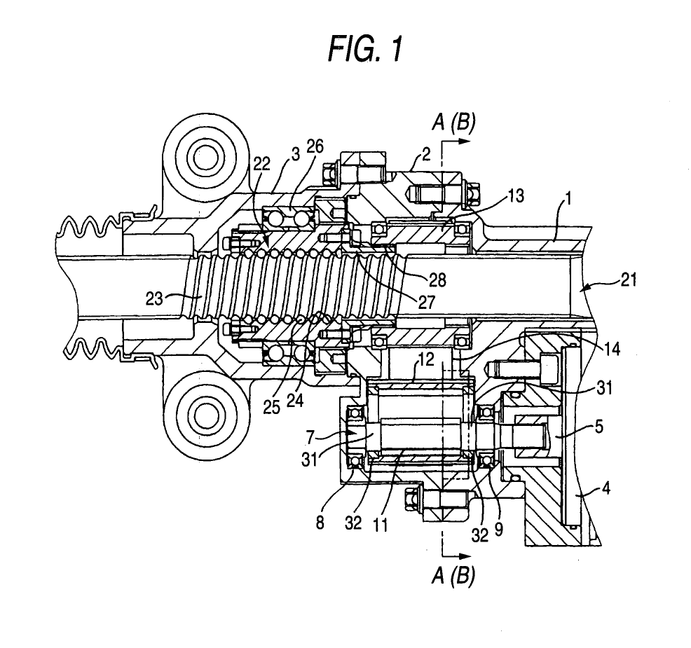

FIG. 1 is a longitudinal sectional view of a ball screw type different shaft type rack-assisting type electric power steering apparatus of an embodiment of the present invention.

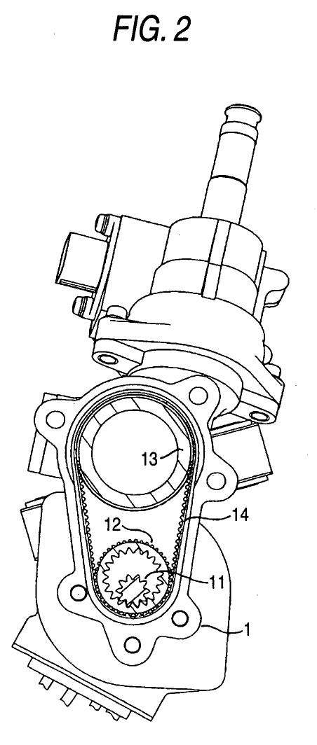

FIG. 2 is a sectional view taken on line A-A (on one-dotted chain line side) in FIG. 1.

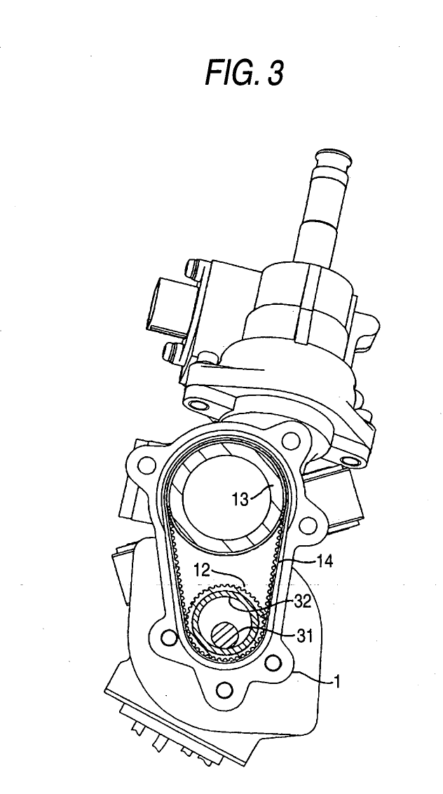

FIG. 3 is a sectional view taken on line B-B (on two-dotted chain line side) in FIG. 1.

In this embodiment, as shown in FIG. 1, housings (steering gear cases) 1, 2, 3 are provided. In the housing 1, an electric motor 4 is arranged.

In a recessed end portion of a drive shaft 5 of this electric motor 4, a pivot shaft 7 is engaged by means of spline engagement. This pivot shaft 7 is pivotally supported by the housings 1, 2 through bearings 8, 9.

On the pivot shaft 7, an external gear 11, the diameter of which is small, having external teeth is arranged. As shown in FIG. 2, the external gear 11 is meshed with a ring-shaped internal-external gear 12 having internal teeth. This internal-external gear 12 is supported being capable of swinging round an axis of the external gear 11. An outer circumferential face of the internal-external gear 12 is composed so that it can act as a drive side pulley. That is, on the outer circumferential face of the internal-external gear 12, engagement teeth, which are meshed with a belt 14 described later, are formed.

Between the engagement teeth on the outer circumferential face of the internal-external gear 12 and engagement teeth on an outer circumferential face of a driven side pulley 13 which is provided on the same shaft as the rack shaft 21 described later, a belt 14, on the inside of which engagement teeth are formed, is provided.

On the other hand, in the housings (steering cases) 1, 2, 3, the rack shaft 21 is housed being capable of freely moving in the axial direction. The rack shaft 21 is attached with a ball screw mechanism having a ball nut 22.

On the rack shaft 21, male screw grooves 23 are formed. On the other hand, on the ball nut 22, female screw grooves 24 are formed. Between the male screw grooves 23 and the female screw grooves 24, a plurality of steel balls 25 as circulation balls are provided. To the ball nut 22, a circulation piece for circulating the steel balls 25 is attached.

The ball nut 22 is supported by the double row bearing 26. By the action of the spline portion 28 arranged in the cylindrical body 27 at the end portion, the driven side pulley 13 can be rotated together with the ball nut 22.

In this embodiment, as shown in FIGS. 1 and 3, at both end portions of the external gear 11, on the substantial same axis, the circular support bodies 31 are arranged. At both end portions of the internal-external gear 12, on the substantially same axis, the annular support bodies 32 for inscribing and supporting the circular support bodies are arranged.

Therefore, a radial force, which is a component of the tension acting on the outer circumferential face of the internal-external gear 12, can be supported by the circular support body 31 and the annular support body 32. Accordingly, both gears 11, 12 can take charge of only a transmission of torque.

Accordingly, the radial force caused by the belt tension does not act on both gears 11, 12. Consequently, there is no possibility that the internal-external gear 12 bites into the external gear 11. Therefore, the durable strength of the tooth can be enhanced and the generation of operation noise can be reduced. Further, the operation torque can be reduced.

An outer diameter of the circular support body 31 is set substantially the same as the diameter of the pitch circle of the external gear 11, and an inner diameter of the annular support body 32 is set substantially the same as the diameter of the pitch circle of the internal teeth of the internal-external gear 12. Therefore, the circular support body 31 and the annular support body 32 come into contact with each other not by sliding contact but by rolling contact. Accordingly, an increase in the operation torque, which is accompanied by friction, can be reduced as small as possible.

In this connection, it should be noted that the present invention is not limited to the above specific embodiment.

In the first embodiment described above, no flanges are provided in the internal-external gear 12. Therefore, when the belt is rotated and moved in the axial direction, there is a fear that a side of the belt 14 comes into contact with the bearing for supporting the driven side pulley 13 or the housings 1, 2.

In this case, the following problems may be encountered. An intensity of operation torque is increased by the friction and abrasion. Further, the durability of the belt is deteriorated. Furthermore, noise is generated by the sliding contact.

Therefore, detailed descriptions will be made into an embodiment below in which the above problems are solved.

The followings are the detailed descriptions of the second to the fourth embodiments in which the circular support body 31 and the annular support body 32 have a movement regulating mechanism for regulating a movement of the internal-external gear 12 in the axial direction in addition to the first embodiment.

### SECOND EMBODIMENT

In this embodiment, the circular support body 31 and the annular support body 32 have a movement regulating mechanism for regulating a movement of the internal-external gear 12 in the axial direction.

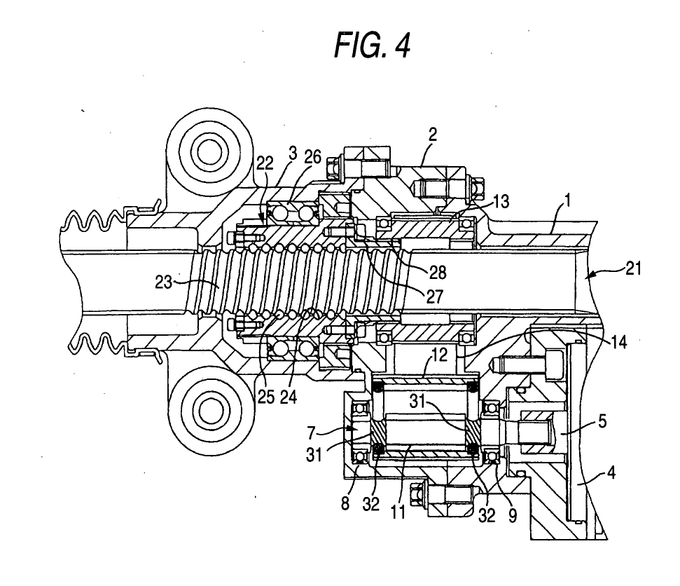

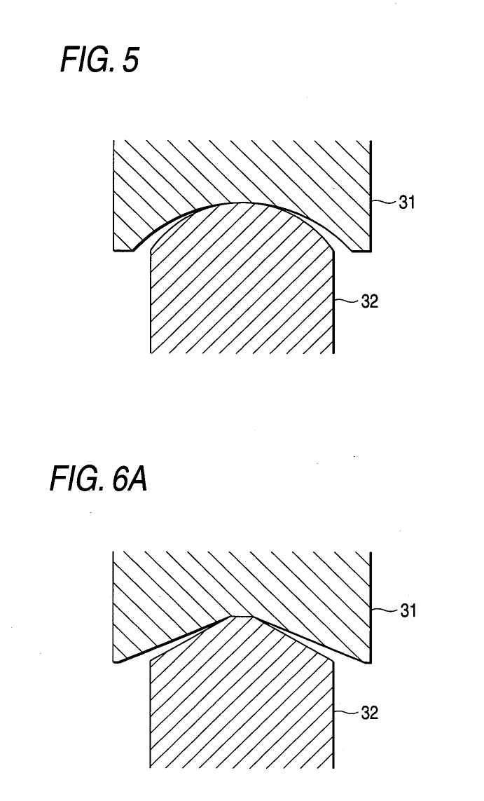

As shown in FIGS. 4 and 5, the movement regulating mechanism is composed in such a manner that an outer circumferential face of the circular support body 31 is formed into a recessed arcuate shape and that an inner circumferential face of the annular support body 32 is formed into a protruded arcuate shape.

When the drive shaft 5 of the electric motor 4 is rotated, the external gear 11 is rotated, and its rotation is transmitted to the internal-external gear 12 and further transmitted to the driven side pulley 13 via the belt 14.

At this time, the belt 14 is to be moved in the axial direction by a direction and inclination of the core wire of the belt and by a twist of the belt 14 itself.

The internal-external gear 12 is also to be moved in the axial direction by a rotational force of the belt 14.

In this embodiment, the outer circumferential face of the circular support body 31 is formed into a recessed arcuate shape, the inner circumferential face of the annular support body 32 is formed into a protruded arcuate shape, and the internal-external gear 12 is pressed in a direction of the driven side pulley 13 by the belt tension at all times.

As a result, the protruded and recessed arcuate shape fulfills a function of the guide. Therefore, the internal-external gear 12 can be regulated from moving in the axial direction. Accordingly, it is possible to prevent from contacting of the internal-external gear 12 with the housings 1, 2.

Therefore, an increase in the operation torque and a deterioration of the durability caused by the sliding contact can be suppressed. Further, the generation of noise can be prevented.

Further, as for the protruded and recessed shapes, for example, a radius of curvature of the protrusion and that of the recess are made to be different from each other. That is, the contact portions of the circular support body 31 and the annular support body 32 are made to be a state of a substantial point contact. Due to this structure, an area of the contact portion is made to be small, that is, rolling contact is accomplished while the contact portion is being made to be in a state of point contact.

Therefore, the occurrence of friction and abrasion can be remarkably reduced.

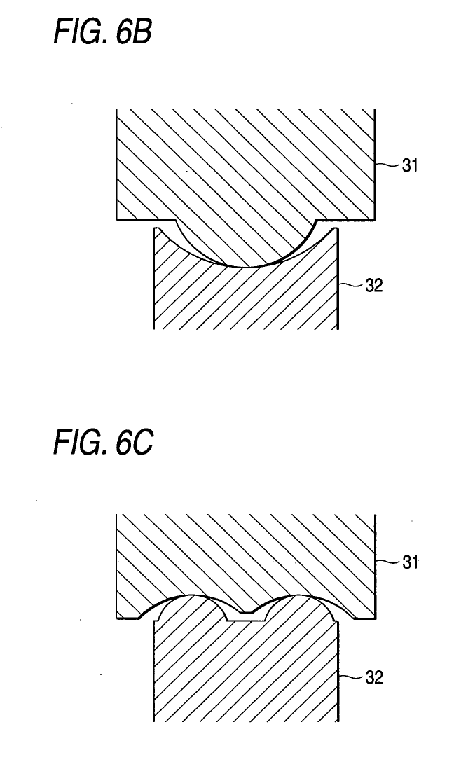

It is sufficient that the protruded and recessed shapes of the circular support body 31 and the annular support body 32 can regulate a movement of the internal-external gear 12 in the axial direction. As shown in FIG. 6A, the protruded and recessed shapes of the circular support body 31 and the annular support body 32 may not be curved faces. Even in the case of a protruded and recessed shape, the protruded portion and the recessed portion may be formed in such a manner that they are contacted with each other by an obtuse angle shape as shown in FIG. 6A. As shown in FIG. 6B, concerning the circular support body 31 and the annular support body 32, a direction of the protruded arcuate shape and that of the recessed arcuate shape may be reverse to each other. As shown in FIG. 6C, a plurality of protruded and recessed arcuate contact portions may be provided.

### THIRD EMBODIMENT

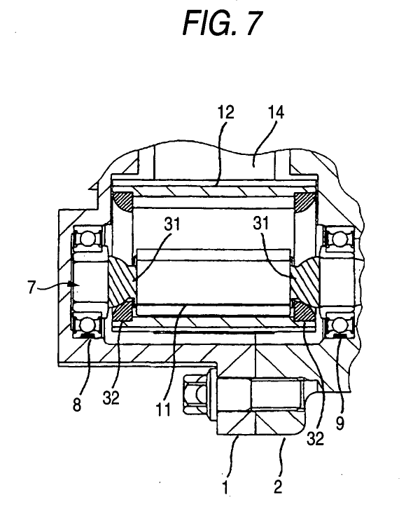

FIG. 7 is an enlarged sectional view showing a primary portion of a ball screw type different shaft type rack-assisting type electric power steering apparatus of the third embodiment of the present invention.

A basic structure of this embodiment is the same as that of the embodiment described above. Only different points will be explained below.

In this embodiment, the circular support body 31 and the annular support body 32 respectively include a movement regulating mechanism for regulating a movement of the internal-external gear 12 in the axial direction.

As shown in FIG. 7, the movement regulating mechanism is composed in such a manner that the contact portions of the circular support body 31 and the annular support body 32 are tapered shaped, opposed to each other and symmetrically to each other.

In this embodiment, when the internal-external gear 12 is to be moved in the axial direction by torque given from the belt 14, in this embodiment, the shapes of the contact portions of the circular support body 31 and the annular support body 32 are formed tapered shape, opposed to each other and symmetrically to each other. Further, the internal-external gear 12 is pressed to the driven pulley 13 side by the tension at all time.

As a result, the thus formed tapered symmetrical shapes function as a guide, and it enables to regulate a movement of the internal-external gear 12 in the axial direction. Accordingly, a contact of the internal-external gear 12 with the housings 1, 2 can be prevented.

Therefore, an increase in the operation torque and a deterioration of the durability caused by the sliding contact can be suppressed. Further, the generation of noise can be prevented.

Further, since the shapes of the contact portions are tapered and symmetrical to each other, the contact portions of the circular support body 31 and the annular support body 32 is substantially close to a point contact. Therefore, an area of the contact portion is small and a rolling contact is made in the contact portion. Accordingly, the occurrence of friction and abrasion can be remarkably reduced.

A direction of the taper of the circular support body 31 and that of the annular support body 32 may be reverse to each other.

### FOURTH EMBODIMENT

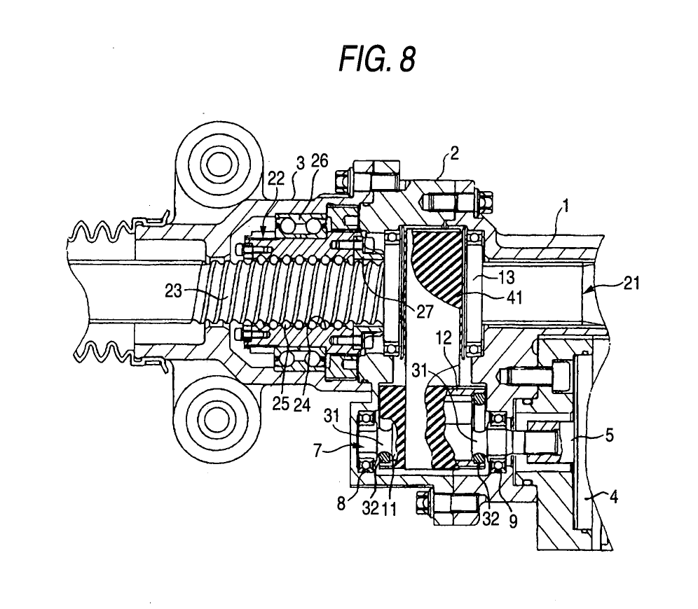

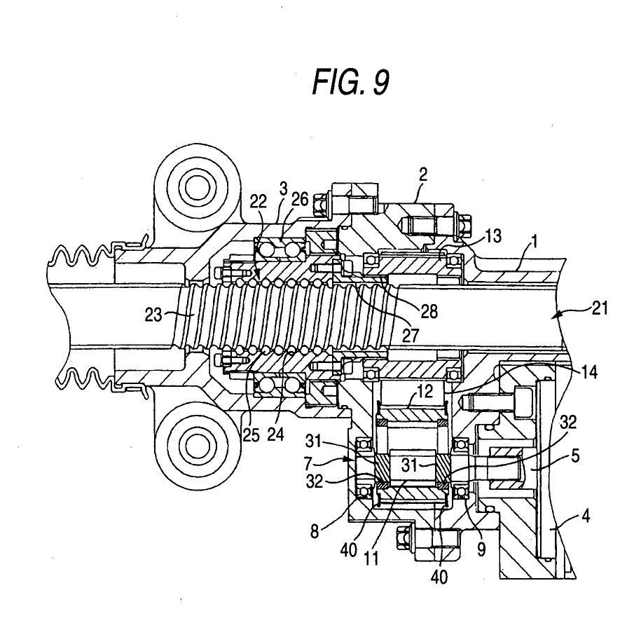

FIG. 8 is a longitudinal sectional view showing a ball screw type different shaft type rack-assisting type electric power steering apparatus of the fourth embodiment of the present invention.

A basic structure of this embodiment is the same as that of the embodiment described above. Only different points will be explained below.

In this embodiment, an oblique tooth belt 41, on the inside of which engagement teeth are formed, is provided between the engagement teeth on the outer circumferential face of the internal-external gear 12 and the engagement teeth on the outer circumferential face of the driven side pulley 13 arranged on the same axis as the rack shaft 21 described later.

When a rotation of the internal-external gear 12 is transmitted to the driven side pulley 13 via the oblique tooth belt 41, the oblique tooth belt 41 is to be moved in the axial direction by the angle of the oblique tooth, the direction and inclination of the core wire and the twist of the oblique tooth belt itself.

In this embodiment, when the oblique tooth belt 41 is to be moved in the axial direction, the outer circumferential face of the circular support body 31 is formed into a recessed arcuate shape, an outer circumferential face of the annular support body 32 is formed into a protruded arcuate shape and the internal-external gear 12 is pressed in the direction of the driven side pulley 13 by the belt tension at all times.

As a result, when the protruded and recessed arcuate shape functions as a guide, a movement of the internal-external gear 12 in the axial direction can be regulated. Accordingly, it is possible to evade the occurrence of a contact of the internal-external gear 12 with the housings 1, 2.

Accordingly, the internal-external gear 12 is neither moved nor contacted with other components. Accordingly, it can be expected that the operation torque is reduced and the generation of noise is prevented. As a result of the reduction of the operation torque, it can be expected that the durable strength of the teeth is enhanced. In other words, it is possible to suppress an increase in the operation torque and a deterioration of the durability caused by the sliding contact. Further, it can be expected that the generation of noise is prevented.

Further, a radius of curvature of the protruded shape and that of the recessed shape are made to be different from each other, and the contact portions of the circular support body 31 and the annular support body 32 is put into a state close to a substantial point contact. Due to the foregoing, the contact portion, the area of which is small (a substantial point contact), is put into a rolling contact. Therefore, the occurrence of friction and abrasion can be remarkably reduced.

In this connection, it should be noted that the present invention is not limited to the above specific embodiment.

Next, the fifth to the seventh embodiment will be explained below in which flanges for regulating a movement of the belt in the axial direction are provided on both sides of the internal-external gear in addition to the first embodiment described above.

### FIFTH EMBODIMENT

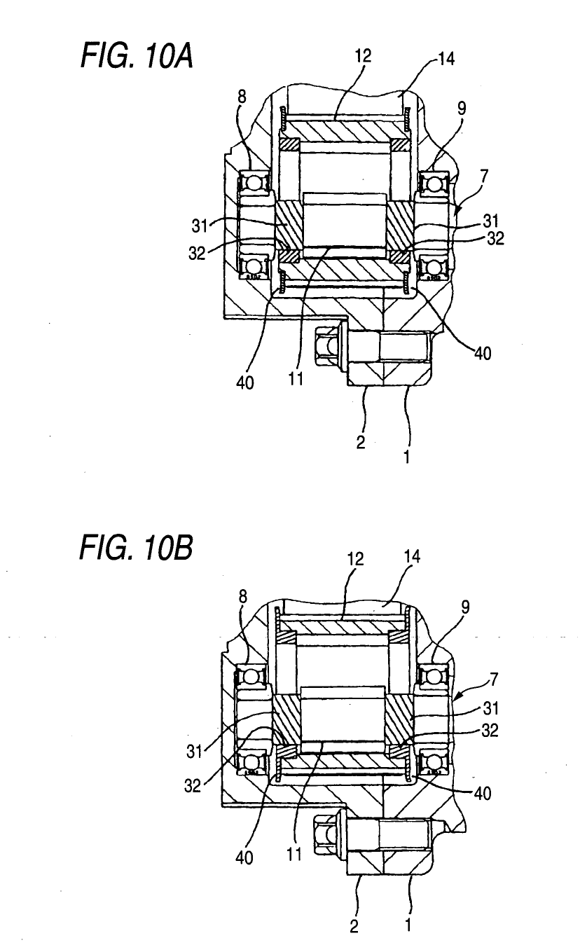

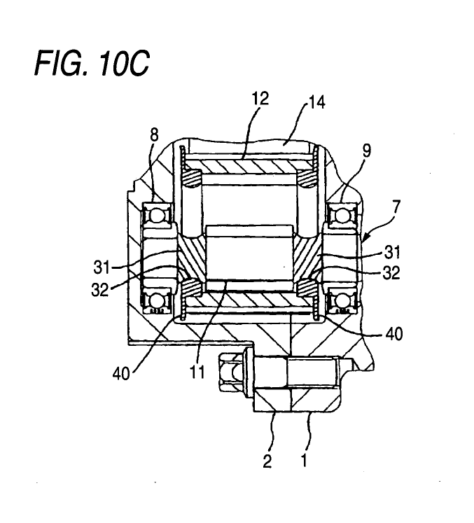

The fifth to the seventh embodiment will be explained below in which flanges 40 for regulating a movement of the belt 14 in the axial direction are provided on both sides of the internal-external gear 12 as shown in FIG. 10A in addition to the first embodiment described above.

When the drive shaft 5 is rotated by the electric motor 4, the external gear 11 is rotated. This rotation is transmitted to the internal-external gear 12 and further transmitted to the driven side pulley 13 via the belt 14. At this time, the belt 14 is to be moved in the axial direction by the direction and inclination of the core wire and by the twist of the belt 14 itself. In the case where the belt 14 is an oblique tooth belt (not shown), the belt 14 is also moved in the axial direction by the angle of the oblique tooth.

In this embodiment, the flanges 40 for regulating a movement of the belt 14 in the axial direction is provided on both sides of the internal-external gear 12 as described before.

Accordingly, it is possible to prevent the belt 14 from moving in the axial direction and coming into contact with the housings 1, 2. Therefore, it is possible to positively prevent an increase of the operation torque, a deterioration of the durability and a generation of noise.

### SIXTH EMBODIMENT

FIG. 10B is an enlarged sectional view of the circular support body and the annular support body of the sixth embodiment of the present invention.

In this embodiment, flanges 40 are integrally formed in the annular support body 32 provided at both end portions of the internal-external gear 12.

Accordingly, in this case, it is possible to prevent the belt 14 from moving in the axial direction and coming into contact with the housings 1, 2. Therefore, it is possible to positively prevent an increase of the operation torque, a deterioration of the durability and a generation of noise.

In addition, since the flanges 40 are formed integral with the annular support body 32, it is possible to omit a means for attaching the flanges separately. Further, it is possible to reduce wall thickness of the attaching portion. Accordingly, the structure can be made compact.

### SEVENTH EMBODIMENT

FIG. 10C is an enlarged sectional view showing a circular support body and an annular support body of the seventh embodiment of the present invention.

In this embodiment, flanges 40 are formed integral with the annular support body 32 provided at an end portion of the internal-external gear 12.

Accordingly, in this case, it is possible to prevent the belt 14 from moving in the axial direction and coming into contact with the housings 1, 2. Therefore, it is possible to positively prevent an increase of the operation torque, a deterioration of the durability and a generation of noise.

Furthermore, since the flanges 40 are formed integral with the annular support body 32, it is possible to omit a means for attaching the flanges separately. Further, it is possible to reduce wall thickness of the attaching portion. Accordingly, the structure can be made compact.

In this embodiment, the circular support body 31 and the annular support body 32 respectively include a movement regulating mechanism for regulating a movement of the internal-external gear 12 in the axial direction. The movement regulating mechanism is composed in such a manner that an outer circumferential face of the circular support body 31 is formed into a recessed arcuate shape and an inner circumferential face of the annular support body 32 is formed into a protruded arcuate shape.

The outer circumferential face of the circular support body 31 is formed into a recessed arcuate shape, and the inner circumferential face of the annular support body 32 is formed into a protruded arcuate shape. The internal-external gear 12 is pressed in a direction of the driven side pulley 13 by the tension of the belt at all times. As a result, the protruded and recessed arcuate shape functions as the guide. Therefore, a movement of the internal-external gear 12 in the axial direction can be regulated. Accordingly, it is possible to prevent the internal-external gear 12 from coming into contact with the housings 1, 2. Accordingly, it is possible to suppress an increase in the operation torque and a deterioration of the durability caused by the sliding contact. Further, it is possible to prevent the generation of noise.

Further, a radius of curvature of the protruded shape and that of the recessed shape are made to be different from each other, and the contact portion of the circular support body 31 and the annular support body 32 is put into a state close to a substantial point contact. Due to the foregoing, the contact portion, the area of which is small (a substantial point contact), is put into a rolling contact. Therefore, the occurrence of friction and abrasion can be remarkably reduced.

It is sufficient that the protruded and recessed shapes of the circular support body 31 and the annular support body 32 can regulate the movement of the internal-external gear 12 in the axial direction. As shown in FIG. 6A, the protruded and recessed shapes of the circular support body 31 and the annular support body 32 may not be curved faces. Even in the case of a protruded and recessed shape, the protruded portion and the recessed portion may be formed in such a manner that they are contacted with each other by a substantial obtuse angle shape. Concerning the circular support body 31 and the annular support body 32, a direction of the protruded arcuate shape and that of the recessed arcuate shape may be reverse to each other. Further, a plurality of protruded and recessed arcuate contact portions may be provided.

In this connection, it should be noted that the present invention is not limited to the above specific embodiment.

Concerning the shapes of the external tooth of the external gear, the internal tooth of the internal-external gear, the outer circumferential face engagement tooth of the internal-external gear, the engagement tooth of the belt and the outer circumferential face engagement tooth of the driven side pulley, straight teeth are used in the first to the third embodiment. However, in the first to the seventh embodiment described above, oblique teeth may be used as shown in the fourth embodiment.

### EIGHTH EMBODIMENT

In the eighth embodiment of the present invention explained below, however, oblique teeth are used for those teeth, and twisting directions of the oblique teeth are set at the same direction. The embodiment will be described in detail as follows.

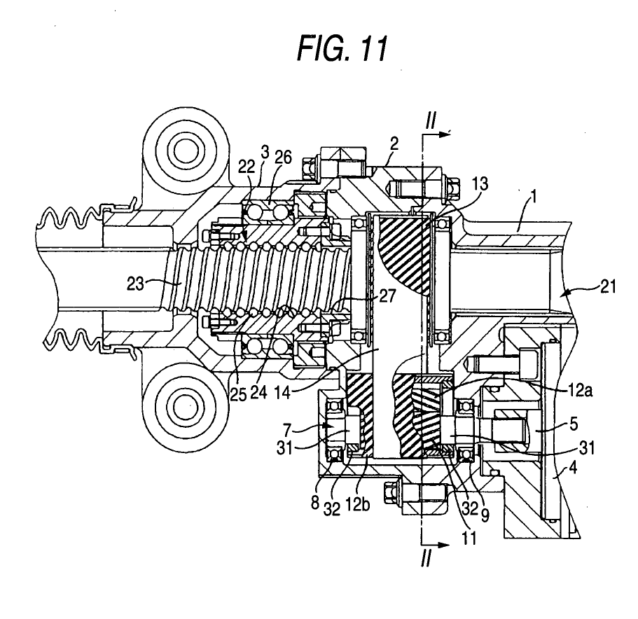

FIG. 11 is a longitudinal sectional view showing a ball screw type different shaft type rack-assisting type electric power steering apparatus of an embodiment of the present invention.

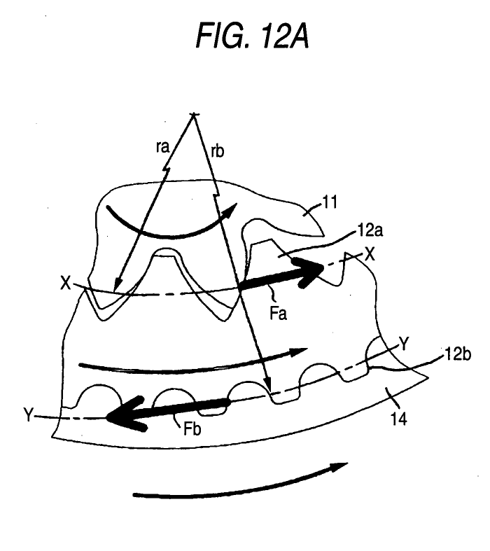

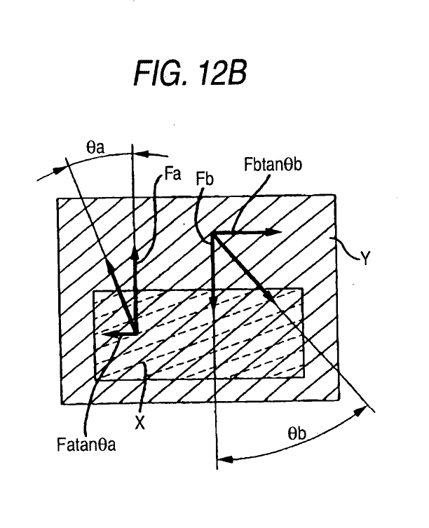

FIG. 12A is an enlarged schematic illustration showing a portion in which the external gear, internal-external gear and belt shown in FIG. 11 are meshed with each other. FIG. 12B is a schematic illustration in which an engagement pitch line (X) of an external tooth of an external gear with an internal tooth of an internal-external gear is shown by a broken line and a pitch line of an outer circumferential face engagement tooth of the internal-external gear with an engagement tooth of a belt is shown by a solid line (Y).

In this embodiment, as shown in FIGS. 12A and 12B, the external tooth of the external gear 11, the internal tooth 12a of the internal-external gear 12, the outer circumferential face engagement tooth 12b of the internal-external gear 12, the engagement tooth of the belt 14 and the outer circumferential face engagement tooth of the driven side pulley 13 are set to be oblique teeth. Twisting directions of these oblique teeth are set in the same direction.

As shown in FIG. 12A, when the external tooth of the external gear 11 and the internal tooth 12a of the internal-external gear 12 are meshed with each other, a tangential force (Fₐ) is generated in the internal-external gear 12.

When the outer circumferential face engagement tooth 12b of the internal-external gear 12 and the engagement tooth of the belt 14 are meshed with each other, a tangential force (F_{b}) is generated in the internal-external gear 12.

As shown in FIG. 12B, component forces acting in the axial direction of the internal-external gear 12 are generated from these tangential forces (Fₐ, F_{b}) by the angle of the oblique tooth. A component force horizontal with respect to the axis of the internal-external gear 12 becomes a force of moving the internal-external gear 12 in the axial direction.

At this time, when the twist directions of the above oblique teeth are set in the same direction, a moving force in the axial direction generated by an engagement of the external tooth of the external gear 11 with the internal tooth 12a of the internal-external gear 12 acts in the opposite direction to a moving force in the axial direction generated by an engagement of the outer circumferential face engagement tooth 12b of the internal-external gear 12 with the engagement tooth of the belt 14.

Due to the foregoing, a moving force in the axial direction, which is to move the internal-external gear 12 in the axial direction, generated by an engagement of the external tooth of the external gear 11 with the internal tooth 12a of the internal-external gear 12 and a moving force in the axial direction, which is to move the internal-external gear 12 in the axial direction, generated by an engagement of the outer circumferential face engagement tooth 12b of the internal-external gear 12 with the engagement tooth of the belt 14 can be set in directions which are reverse to each other. As a result, it is possible to regulate a movement of the internal-external gear 12 in the axial direction.

When the twist angle of the internal tooth 12a of the internal-external gear 12 is θₐ and the twist angle of the outer circumferential face engagement tooth 12b of the internal-external gear 12 is θ_{b}, in order for the above two moving forces in the axial direction to act in the directions opposite to each other and in order for the above two moving forces in the axial direction to be balanced to each other, it is sufficient that the following Formula 1 is satisfied.
Fₐ tan θₐ=F_{b} tan θ_{b} (1)

When an engagement pitch circle radius of the internal tooth 12a of the internal-external gear 12 is rₐ and an engagement pitch circle radius of the outer circumferential face engagement tooth 12b of the internal-external gear 12 with the engagement tooth of the belt 14 is r_{b} in FIG. 12A, the tangential forces (Fₐ, F_{b}) can be respectively found by the torque acting on the engagement portion by Formula 2 described as follows.
Fₐ=Tₐ/rₐ, F_{b}=T_{b}/r_{b} Formula 2

Therefore, Formula (1) can be expressed by Formula 3 as follows.
(Tₐ/rₐ)tan θₐ=(T_{b}/r_{b})tan θ_{b} Formula 3

In this case, of course, the internal tooth 12a of the internal-external gear 12 and the outer circumferential face engagement tooth are integrated with each other into one body and the torque to be transmitted is the same.

Therefore, Tₐ=T_{b}.

Accordingly, the following formula is calculated.
r_{b}/rₐ=tan θ_{b}/tan θₐ Formula 4

Therefore, according to the present embodiment having the twist angle described above, a moving force in the axial direction, which is generated in the internal tooth 12a of the internal-external gear 12, and a moving force in the axial direction, which is generated in the outer circumferential engagement tooth, can be canceled to each other. Accordingly, a movement of the internal-external gear 12 in the axial direction can be regulated.

Accordingly, the movement of the internal-external gear 12 in the axial direction can be regulated. It is possible to suppress an increase in the operation torque and a deterioration of the durability. Further, the generation of noise can be prevented.

In this connection, it should be noted that the present invention is not limited to the above specific embodiment and variations are adaptable.

Note that the above electric power steering apparatus may be used for a usual steering mechanism by which front wheels are steered. Of course, the above electric power steering apparatus may be used for steering front wheels or rear wheels of 4-wheel-steering-mechanism.

The present invention can be applied to a so-called steer-by-wire (SBW) type steering mechanism in which a steering wheel and a rack shaft are not mechanically connected to each other. In addition, the present invention includes combinations in which the first to the eighth embodiment are combined with each other.

The present invention has been explained above in detail referring to specific embodiments. However, it should be noted that variations can be made by those skilled in the art without departing from the spirit and scope of the present invention.

The present application is based on Japanese Patent Application (2004-381681) filed on Dec. 28, 2004, Japanese Patent Application (2005-017257) filed on Jan. 25, 2005, Japanese Patent Application (2005-022075) filed on Jan. 28, 2005 and Japanese Patent Application (2005-082230) filed on Mar. 22, 2005. Therefore, the contents of the above patent applications are taken in here.

### INDUSTRIAL APPLICABILITY

According to the present invention described above, a radial force, which is a component of the belt tension acting on the internal-external gear, can be supported by the circular support body and the annular support body. Therefore, both gears take charge of only a transmission of torque.

Accordingly, the radial force caused by the belt tension does not act on both gears. Consequently, there is no possibility that the internal-external gear bites into the external gear. Therefore, it is possible to provide an electric power steering apparatus in which the durable strength of the tooth can be enhanced and the generation of operation noise can be reduced and further the operation torque can be reduced.

1. A different shaft type rack-assisting type electric power steering apparatus, in which an auxiliary steering torque is generated by an electric motor in accordance with a steering torque impressed upon a steering wheel and transmitted to a rack shaft of a steering mechanism via a power transmission mechanism, the power transmission mechanism including:
an external gear of which diameter is small, which is driven by the electric motor and has external teeth;
a ring-shaped internal-external gear, which has internal teeth inscribed and meshed with the external gear, is swingably supported around an axis of the external gear, and an outer circumferential face of which acts as a drive side pulley;
a driven side pulley driven by the internal-external gear via a belt; and
a ball screw mechanism driven by the driven side pulley so as to move the rack shaft,
wherein a circular support body is substantially concentrically provided at an end portion of the external gear; and
an annular support body, which supports the circular support body, is substantially concentrically provided at an end portion of the internal-external gear so as to be inscribed with the circular support body.

2. The electric power steering apparatus according to claim 1, wherein an outer diameter of the circular support body is set substantially the same as a pitch circle diameter of the external gear, and
an inner diameter of the annular support body is set substantially the same as a pitch circle diameter of the internal teeth of the internal-external gear.

3. The electric power steering apparatus according to claim 1, wherein the circular support body and the annular support body respectively has a movement regulating mechanism for regulating a movement of the internal-external gear in the axial direction.

4. The electric power steering apparatus according to claim 3, wherein an outer diameter of the circular support body is set substantially the same as a pitch circle diameter of the external gear, and
an inner diameter of the annular support body is set substantially the same as a pitch circle diameter of the internal teeth of the internal-external gear.

5. The electric power steering apparatus according to claim 3, wherein in the movement regulating mechanism, shape of contact portions, in which the circular support body contacts with the annular support body, are formed in such a manner that one is formed into a protruding shape and the other is formed into a recessing shape.

6. The electric power steering apparatus according to claim 3, wherein in the movement regulating mechanism, shape of contact portions, in which the circular support body contacts with the annular support body, are formed in such a manner that both are formed into tapered shape, opposed to each other and symmetrically to each other.

7. The electric power steering apparatus according to claim 1, wherein a flange is provided on a side of the internal-external gear.

8. The electric power steering apparatus according to claim 7, wherein the flange is formed integrally with the annular support body, which is provided at an end portion of the internal-external gear.

9. The electric power steering apparatus according to claim 1, wherein external teeth of the external gear, internal teeth of the internal-external gear, outer circumferential face engagement teeth of the internal-external gear, engagement teeth of the belt and outer circumferential face engagement teeth of the driven side pulley are respectively set to be oblique teeth, and
twist directions of these oblique teeth are set to be in the same direction.

10. The electric power steering apparatus according to claim 9, wherein
twist angle of the internal tooth of the internal-external gear is set θₐ,
twist angle of the outer circumferential face engagement tooth of the internal-external gear is set θ_{b},
pitch circle radius of engagement of the internal tooth of the internal-external gear is set rₐ, and
pitch circle radius of engagement of the outer circumferential face engagement tooth of the internal-external gear with the engagement tooth of the belt is set r_{b},
wherein θₐ, θ_{b}, rₐ and r_{b} are set so as to satisfy following relation.
(r_{b}/rₐ)=(tan θ_{b}/tan θₐ) (Formula 4)

11. The electric power steering apparatus according to claim 1, wherein the electric power steering apparatus is used for steering rear wheels in a four wheel steering system.

12. The electric power steering apparatus according to claim 1, wherein the electric power steering apparatus is used for a steer-by-wire type steering system in which the steering wheel and the rack shaft are not mechanically connected to each other.
